(19) United States
(12) Patent Application Publication
(10) Pub. No.: US 2022/0268666 A1
(43) Pub. Date: Aug. 25, 2022

(54) A CLIMATE HALL FOR VEHICLE TESTING

(71) Applicant: STAR LAKE HOLDING AB, VIDSEL (SE)

(72) Inventors: Anders VIDHAV, JONSTORP (SE); Per-Thore FALKENDAL NILSEN, SVELVIK (NO)

(21) Appl. No.: 17/599,600

(22) PCT Filed: Mar. 25, 2020
(86) PCT No.: PCT/EP2020/058370

§ 371 Date: Sep. 29, 2021

(30) Foreign Application Priority Data
Apr. 12, 2019 (SE) 1950458-8

(51) Int. Cl. G01M 17/007; E04H 15/22

(52) U.S. Cl. CPC G01M 17/007; E04H 15/22

(57) ABSTRACT

A climate hall including a foundation to which a flexible wall arrangement is connected. The flexible wall arrangement extends along and is sealingly joined to the foundation. The climate hall further includes a ventilation plant. The ventilation plant is configured to establish an overpressure inside the flexible wall arrangement, thereby causing the flexible wall arrangement to erect to form a hall having an inner volume which is at least partly defined by inner side wall portions and a ceiling portion formed by the flexible wall arrangement. The ventilation plant is further configured to established a controlled climate inside the hall, thereby forming a climate hall. The climate hall further includes an interior ground surface configured for vehicle testing.

### TECHNICAL FIELD

The present invention generally relates to vehicle testing facilities, and in particular to climate halls providing variable climate conditions, increased safety, at a lower cost than compared to conventional vehicle test halls.

### BACKGROUND OF THE INVENTION

The automotive industry is faced with a number of challenges, where new transportation methods, choice of fuel and engine types will change the way the need of transportation will be handled in the future. Already in the nineties the industry concluded that extreme cold is the biggest challenge for a vehicle and in that conclusion lies the background to the steady growth of vehicle testing at winter conditions, for the past 30 years. Development and testing of new products in extreme cold is a better way of quickly finding weaknesses and problems as compared to testing at hot conditions.

The demand for winter testing possibilities increases continuously due to increased volumes as well as the automotive industry's need to shorten lead times in the process of model development. However, when performing vehicle tests at arctic climate conditions, there is usually also a need for performing reference measurement at warmer climate conditions. Consequently, after having finished a series of outdoor tests at winter conditions, the vehicle must be transported to a warmer climate zone in order to perform the reference tests. Such transportation is both costly and time consuming, and also affects the global environment negatively. Furthermore, the increasing need of cold climate testing in combination with a winter season that becomes shorter year by year has resulted in a drastic increase in demand for efficient proving ground with stable and controllable climatic conditions.

This has led to climate halls being built on a few places, foremost in northern Europe. These halls are all built in a traditional way, using concrete, steel and metal sheet which results in size limitation since it's challenging to build the large halls required for these types of test. Furthermore, this traditional way of building the halls results in safety issues both with respect to the walls and with respect to the many supporting poles needed to support the roof. These poles are present in the vehicle test areas as well, thus increasing the risk of collisions. These halls are also extremely expensive to produce which, due to financial reasons, reduces the chances of building halls of sufficient size to perform complete test programs. There is hence a need for another solution of providing halls for vehicle testing which also allows a controlled climate.

### SUMMARY OF THE INVENTION

In view of the above, an objective of the invention is to provide a climate hall for vehicle testing, that provides variable climate conditions, increased safety by reduced risk of collisions, and at a lower building cost than compared to conventional vehicle test halls.

According to a first aspect, the present invention is realized by a climate hall for vehicle testing. The climate hall comprises a foundation, a ventilation plant, and a flexible wall arrangement extending along and sealingly joined to the foundation. The ventilation plant is configured to establish an overpressure inside the flexible wall arrangement. The overpressure causes the flexible wall arrangement to erect to form a hall having an inner volume which is at least partly defined by inner side wall portions and a ceiling portion formed by the flexible wall arrangement. The ventilation plant is further configured to establish a controlled climate inside the hall, thereby forming a climate hall. The climate hall further comprises at least an interior ground surface configured for vehicle testing. The interior ground surface comprises a test arrangement with one or more environmental features from of a group of consisting of asphalt, ice, snow, water, sand, gravel, stone, dirt, a designed friction surface and rail.

By the term “controlled climate” is here meant that air temperature and air humidity inside the climate hall may be controlled. The air temperature may be controlled by a heating element such as a radiator, or a cooling element such as a chiller, air conditioning system, or any other means for controlling air temperature. Similarly, the air humidity may be controlled by a humidifier, dehumidifier, or any other means for controlling air humidity. Further, the system for controlling the climate inside the climate hall may comprise means for circulation of the air inside the hall. The system may also comprise means for air replacement, such as fresh air intake and outlet of air from the hall containing traces of vehicle exhaust gases. Systems for climate control and air handling as such are well known to the person skilled in the art.

By the term “stone” is here meant any ground surface comprising stone of any form either naturally occurring or man-made. By way of example, the term “stone” comprises rocks, cliffs, and cobble road.

By the term “designed friction surface” is here meant any ground surface that has been designed to provide a specific friction between the vehicle and the ground surface. This includes surfaces designed to have e.g. a high or low friction coefficient, p. This may further comprise surfaces on which the friction coefficient is different on different segments of the surface, for example by being split providing a high friction coefficient on one side and a low friction coefficient on the other side of the vehicle, sometimes referred to as Split-μ conditions. Designed friction surfaces may further comprise surfaces with alternating friction coefficients along the direction of propagation of the vehicle. One example is a checker board pattern where the different squares have alternating high and low friction coefficients. Given only as examples, the ground surface segments with high and low friction coefficients may be, but is by no means limited to, a combination of alternating asphalt and polished ice. In order to achieve the different ground surface environments, at least part of the interior ground surface of the climate hall may comprise a system for temperature control of the interior ground surface.

By a climate hall for vehicle testing as prescribed above, the need for supporting poles to support the ceiling is eliminated. Instead the hall is supported by the overpressure established and maintained by the ventilation plant. Accordingly, the climate hall may be seen as a self-supporting arrangement. Consequently, the safety level in the climate hall is significantly increased, compared to conventional climate halls, as the risk of accidental collision with such poles is thereby also eliminated. Further, the present arrangement allows for more flexibility regarding the size and shape of the climate hall. Thus the limitations regarding size and design that often restrict the construction of conventional climate halls, are also eliminated. In other words, by the present arrangement a climate hall without supporting poles and thus improved safety, with more flexibility regarding size and design, and at a lower construction cost than conventional climate halls, may be provided.

The climate hall may comprise a fender system arranged along at least a part of the inner side wall portions.

By the term “fender” is here meant any unit, device, and/or element designed to absorb kinetic energy from a vehicle upon collisional impact. By way of example, such fenders may be filled with air, soft cushion material, or any other material suitable for softening the impact by energy absorption.

The fender system may comprise at least two deformation zones arranged one after the other as seen in a direction from the inside of the climate hall towards the flexible wall arrangement.

The fender system may be integral with the inner side wall portion of the flexible wall arrangement, or the fender system may be a standalone unit.

An advantage with this embodiment is that in case the driver should lose control of the vehicle and the vehicle accidentally runs off the track of the test arrangement, and thereby travels towards the wall of the climate hall, the fender system will absorb the kinetic energy from a vehicle upon impact, thereby slowing the vehicle down and hereby substantially reducing the risk of personal injuries to the driver as well as damages to the vehicle. Another advantage with this embodiment is that, by slowing down the vehicle, preferably to a complete stop, prior to the vehicle reaching the wall of the climate hall, it substantially reduces the risk of damages also to the wall of the climate hall. Accordingly, by the present arrangement a climate hall in which safety is further improved, may be provided.

At least a part of the ceiling portion may be provided with a heating foil. The heating foil is preferably arranged across an upper most portion of the ceiling portion. It is to be understood that the area covered by a heating foil may be locally enlarged. By way of example, the heating foil may have a larger surface extension on the north side of the climate hall than on the south side.

By the term “heating foil” is here meant any unit, device, and/or element with the capability of keeping the surface on which it's arranged, at a defined temperature, and/or increase the temperature thereof. By way of example, the heating foil may be, but is not in any way limited to, heating films, PTC (Positive Temperature Coefficient) rubber heating elements, or any other type.

An advantage with this embodiment is that the heating foil may melt ice and/or snow, and thereby eliminate formation of ice and accumulation of snow masses on the roof of the climate hall during winter. If the ice and/or snow is not removed it may affect the construction of the climate hall negatively. This is especially important when the climate hall is run as a cold climate test hall. By the present arrangement a climate hall in which the climate can be set independently from the outdoor climate without the climate hall's construction being affected by formation of ice and/or snow masses on the roof, may be provided.

The flexible wall arrangement may be a double wall structure comprising an inner wall and an outer wall, and wherein at least a part of an inner wall portion of the outer wall may be provided with a heating foil.

By the term “double wall structure” is here meant any flexible wall arrangement comprising an inner wall and an outer wall, and where the inner and outer walls are not in physical contact with each other at least for a major part of the wall area. The inner and outer walls may be in local contact with each other along joints. In between the inner wall and outer wall is a layer of air supplied by the ventilation plant, keeping the inner wall and the outer wall essentially separated. The air layer contributes to the geometrical shaping of the climate hall and hence to the overall robustness.

In the manner described above the air inside the climate hall and the air outside the climate hall are separated by the layer of air between the inner wall and the outer wall. By the present arrangement a better insulation between the indoor and outdoor climate may be provided.

The interior ground surface inside the climate hall may be arranged in level with or above an upper portion of the foundation.

An advantage with this embodiment is that in case the driver loses control of the vehicle and the vehicle accidentally travels towards the wall of the climate hall, the vehicle may run through the flexible wall arrangement without the risk of colliding with a solid foundation at high impact. By the present arrangement the risk of personal injuries to the driver as well as damages to the vehicle are substantially reduced.

An exterior ground surface outside of the climate hall, as seen adjacent the foundation, may be arranged below the upper portion of the foundation.

In the case of winter climate outside of the climate hall, ice and/or snow may gather on the exterior ground surface adjacent the outer wall of the climate hall. By way of example, snow may run down from the roof along the outer walls of the climate hall, and accumulate at the exterior ground surface adjacent the foundation. In the manner described above, snow clearance by means of a snow plow may be performed along the outer wall of the climate hall, with the snow plow only coming in contact with the foundation but not with the flexible wall arrangement. In this manner the risk of tearing the flexible wall arrangement by the snow plow is eliminated.

The climate hall may further comprise an illumination arrangement, wherein the illumination arrangement is recessed into the interior ground surface of the climate hall, at least along inner side walls of the climate hall.

Conventional illumination arrangements mounted in the ceiling may provide only patchy illumination in the climate hall, and may also cause the driver of the vehicle to be dazzled by the uneven illumination. Further conventional light posts will constitute a safety risk for drivers. An advantage with the above mentioned embodiment is that the light from the arrangement recessed into the interior ground surface of the climate hall may illuminate the inner side wall and ceiling portions of the climate hall. The inner side wall and ceiling portions will act as a diffusor of the light. Hence, the recessed illumination arrangement in combination with the inner side wall and ceiling portions may be seen as providing an indirect illumination of the climate hall. Preferably the inner side wall and ceiling portions have a light, e.g. white, inner surfaces. By the present arrangement a more homogeneous illumination in the climate hall may be provided, and the risk of light dazzling the driver of the vehicle may be eliminated.

The interior ground surface may further comprise a vehicle acceleration section having a length of at least 25 meters, more preferred at least 75 meters, and even more preferred at least 150 meters. The interior ground surface may further comprise a vehicle test section having a length of at least 150 meters, more preferred at least 400 meters, and even more preferred at least 800 meters.

Designed friction surfaces may be arranged on the interior ground surface of the vehicle test section. Such designed friction surfaces may be divided into a plurality of sections. The plurality of sections may be arranged in several different ways, for example they may be arranged linearly along the length of the climate hall, or they may be arranged in parallel tracks across the width of the climate hall.

Other objectives, features and advantages of the present invention will appear from the following detailed disclosure, from the attached claims as well as from the drawings.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE ENCLOSED FIGURES

The above, as well as additional objects, features and advantages of the present invention, will be better understood through the following illustrative and non-limiting detailed description of preferred embodiments of the present invention, with reference to the appended drawings. The same reference numerals will be used for similar elements throughout the drawings.

FIG. 1 discloses an exterior view of an example of a climate hall for vehicle testing.

FIG. 2 discloses an example of an interior ground surface configuration of a climate hall for vehicle testing.

FIG. 3 discloses an integrated fender system arranged along at least a part of an inner side wall of a climate hall for vehicle testing.

FIG. 4 discloses a vertical cross-section of a climate hall with a double wall structure, a heating foil arranged in parts of the ceiling portion, and an illumination arrangement recessed into the interior ground surface.

FIG. 5 discloses a climate hall with an interior ground surface arranged in level with an upper portion of a foundation, and an exterior ground surface arranged below an upper portion of the foundation.

### DETAILED DESCRIPTION OF PREFERRED EMBODIMENTS

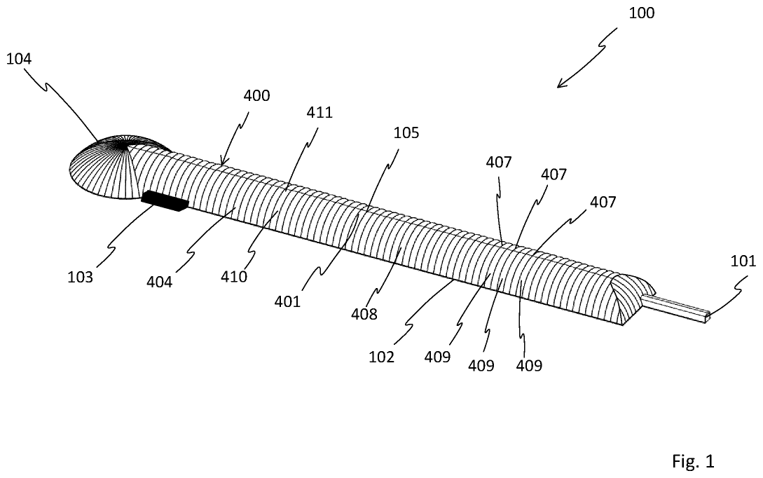

FIG. 1 illustrates an exterior view of a climate hall 100 for vehicle testing according to an embodiment of the invention.

The climate hall 100 comprises in its broadest form a foundation 102 to which a flexible wall arrangement 400 is connected. The flexible wall arrangement 400 extends along and is sealingly joined to the foundation 102. The climate hall 100 further comprises a ventilation plant 103. The ventilation plant 103 is configured to establish an overpressure inside the flexible wall arrangement 400, thereby causing the flexible wall arrangement 400 to erect to form a hall having an inner volume which is at least partly defined by inner side wall portions 408 and a ceiling portion 401 formed by said flexible wall arrangement 400. The ventilation plant 103 is further configured to establish a controlled climate inside the hall, thereby forming the climate hall 100.

As is illustrated in FIG. 1, in the present embodiment the flexible wall arrangement 400 expands a large dome 104 in one end of the climate hall 100. From the dome 104, the flexible wall arrangement 400 extends in a long arm 105 of the climate hall 100. The present embodiment also features an air lock 101 for vehicle entry into the climate hall 100. The air lock 101 may be a simple air lock for allowing vehicles to enter and exit the climate hall 100, but it may also house other (non-disclosed) facilities. One such facility can be a (non-disclosed) vehicle wash facility allowing vehicles to be washed prior to entering test sections of the climate hall 100. Thereby it is avoided that dirt, road salt, oil or other unwanted impurities enter the climate hall 100. It should be noted that the presented embodiment is only one example of the climate hall 100, and that the climate hall 100 is not limited to this embodiment. For example, other embodiments may comprise more than one arm 105 extending at different angles from the dome 104. Other embodiments may comprise one or more arms 105 without a dome 104 present.

In the disclosed embodiment, the climate hall 100 comprises a generally arched or dome shaped configuration comprising side walls 410 merging into a roof section 411. The side walls 410 and the roof section 411 are formed by the flexible wall arrangement 400 having a continuous extension. The flexible wall arrangement 400 may be formed by a plurality of interconnected large flexible sheets 409 which are joined e.g. by sewing, adhesive bonding or welding. The joints 407 contribute to providing the overall geometry of the climate hall 100. It is hence to be understood, that depending on how the joints 407 are arranged, a different geometry may be provided for. By way of example, the side walls 410 and the roof section 411 do not need to be arc shaped. In another, non-disclosed embodiment, one or both of the side walls 410 and the roof section 411 may have a substantially straight surface extension. In such non-disclosed embodiment, a main plane of the side wall(s) form an angel in view of the main plane of the roof section.

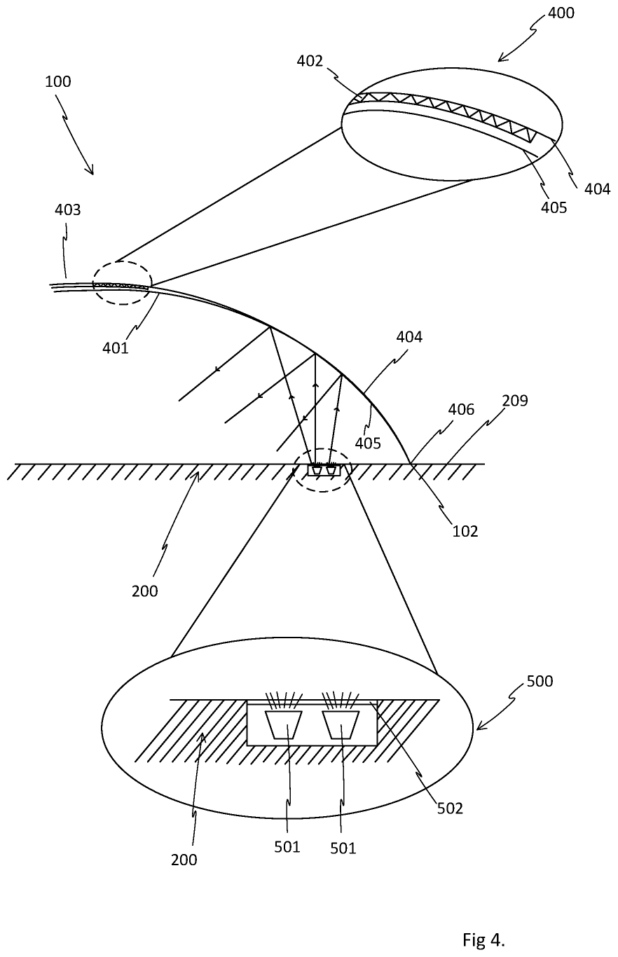

As illustrated in FIG. 4, the flexible wall arrangement 400 may be a double wall structure comprising an inner wall 405 and an outer wall 404. The invention is, however, not limited to a double wall structure only. In other, non-disclosed embodiments, the flexible wall arrangement 400 may comprise different number of wall layers, for example one, two, three, or four wall layers. Different sections of the climate hall 100 may have different wall configurations.

In the present arrangement with a double wall structure, the inner wall 405 and outer wall 404 may be sealingly connected to each other along joints 406 extending along and adjacent the foundation 102 of the climate hall 100. A layer of air supplied by the ventilation plant 103 may be provided between the inner wall 405 and outer wall 404. Thereby the inner wall 405 and the outer wall 404 will be essentially separated. The present double wall arrangement provides a better insulation between the indoor and outdoor climate as compared to a single wall structure.

The flexible wall arrangement 400 may be made by any flexible, yet air tight and water resistant material, such as soft plastic, rubber, canvas or tarpaulin. The skilled person will understand that also other materials are possible.

Now returning to FIG. 1. As given above, the flexible wall arrangement 400 extends along and is sealingly joined to the foundation 102 of the climate hall 100. The foundation 102 may be made of, but is not limited to, concrete. The foundation 102 may be at least partly located below the ground surface as seen along the exterior rim of the climate hall 100. The foundation 102 and the flexible wall arrangement 400, along with the interior ground surface 200 of the climate hall 100 create a substantially air sealed volume.

In the present embodiment a ventilation plant 103 is arranged on one of the outer side walls 404 of the climate hall 100. As given above, the ventilation plant 103 is configured to establish and maintain an overpressure inside the volume that is partly defined by the flexible wall arrangement 400. The overpressure causes the flexible wall arrangement 400 to erect to form a climate hall 100 with an inner volume defined by the flexible wall arrangement 400, the foundation 102 and the interior ground surface 200. Accordingly, the present arrangement creates a self-supporting construction. The self-supporting construction eliminates the need for walls and roof constructed of steel and/or concrete as well as the need for supporting poles otherwise present in conventional climate halls.

Not only does the ventilation plant 103 establish and maintain an overpressure in the climate call 100, but it also establishes a controlled climate inside the climate hall 100. The ventilation plant 103 may be equipped with cooling/freezing capacity as well as heating capacity. Thereby the desired climate inside the climate hall 100 can be created independently of the outdoor climate. Consequently, the climate hall 100 can establish and also switch between e.g. arctic climate and warmer climate. Similarly, the air humidity may be controlled by the ventilation plant 103.

Furthermore, the indoor environment in terms of exhaust levels, may be controlled by the ventilation plant 103. In one embodiment of the climate hall 100, gas sensors (not disclosed) may be installed inside the climate hall 100. The gas sensors may be configured to detect the level of exhaust gases present in the air inside the climate hall 100. By utilizing the readings for the gas sensors, better control of the air quality inside the climate hall 100 may be accomplished.

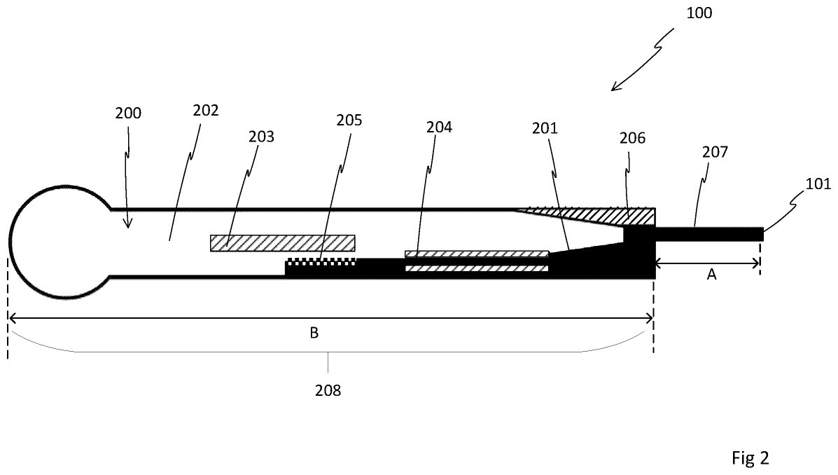

FIG. 2 illustrates the interior ground surface 200 of the climate hall 100 according to an embodiment of the invention. The present embodiment is a non-limiting example of an interior ground surface 200 suitable for testing of vehicles such as personal cars, motorcycles, buses or trucks. However, many other interior ground surface configurations are possible, and suitable also for other types of vehicles.

In the present embodiment the vehicle (not disclosed) can enter the climate hall 100 via the vehicle air lock 101, where one typical ground surface may be asphalt 201. From the vehicle air lock 101 a vehicle acceleration section 207 extends towards the main part of the climate hall 100. Also in this section, the typical ground surface may be asphalt 201. The vehicle acceleration section 207 may have a length A of at least 25 meters, more preferred at least 75 meters, and even more preferred at least 150 meters. The vehicle acceleration section 207 may be configured to allow acceleration of the test vehicle to the desired speed before entering the vehicle test section 208.

The vehicle test section 208 may comprise one or more environmental features from of a group of consisting of asphalt, ice, snow, water, sand, gravel, stone, dirt, a designed friction surface and rail. The interior ground surface 200 of the vehicle test section 208 may at least partly be essentially flat, with either a horizontal orientation or with an inclination with an angle with respect to the horizontal orientation. The angle may be different in different parts of the interior ground surface 200. The interior ground surface 200 may also comprise parts with rough road conditions, on which the angle may vary. Rough road conditions may also comprise a combination of different environmental features. Given as a non-limiting example, rough road conditions may comprise a combination of gravel, stone and dirt.

As illustrated in FIG. 2, in the present embodiment a major part of the interior ground surface 200 is covered by packed snow 202. This is a typical ground surface for vehicle testing at arctic climate conditions. Along the driving direction there is also an optional long strip of polished ice 203 in the vehicle test section 208. This is a non-limiting example of ground surface environment chosen to achieve a low friction coefficient between the ground surface 200 and the wheels of the vehicle. The interior ground surface 200 of the vehicle test section 208 may also comprise an optional section with frozen rough road conditions 206. Other areas of the vehicle test section 208 may comprise surfaces on which the friction coefficient is different on different segments of the surface. One example is the so called Split-μ conditions 204, where the ground surface properties are split providing a high friction coefficient for the wheels on one side of the vehicle and a low friction coefficient for the wheels on the other side of the vehicle with respect to the driving direction of the vehicle.

According to the present embodiment, the interior ground surface 200 may also comprise an optional area with a so called checker board pattern 205 where the different squares in the pattern have alternating high and low friction coefficients. Given only as examples, the ground surface segments with high and low friction coefficients may be, but is by no means limited to, a combination of alternating asphalt and polished ice.

As illustrated in FIG. 2, the vehicle test section 208 may further comprise a number of optional parallel test tracks, with different ground surface environments. These tracks may be used in either the same or opposing directions.

The skilled person will understand that the interior ground surface 200, depending on the types of tests to be performed may be designed in a number of ways and that the examples disclosed are non-limiting.

In order to achieve the different ground surface environments, the interior ground surface 200 of the climate hall 100 may comprise a system for temperature control (not disclosed) of the interior ground surface 200. One purpose of such a system may be to establish a ground surface temperature below the freezing point, but it may also be to rise the ground surface temperature above the freezing point. Such a ground surface temperature control system may be a part of the ventilation plant 103, or it may be a stand-alone system. It is to be understood that different areas of the interior ground surface 200 may be set to have different temperatures.

The entire vehicle test section 208 may have a length B of at least 150 meters, more preferred at least 400 meters, and even more preferred at least 800 meters. It is preferred that the vehicle test section 208 should be long enough to be suitable for many different types of vehicle tests. Thereby a versatile climate hall 100 may be provided for.

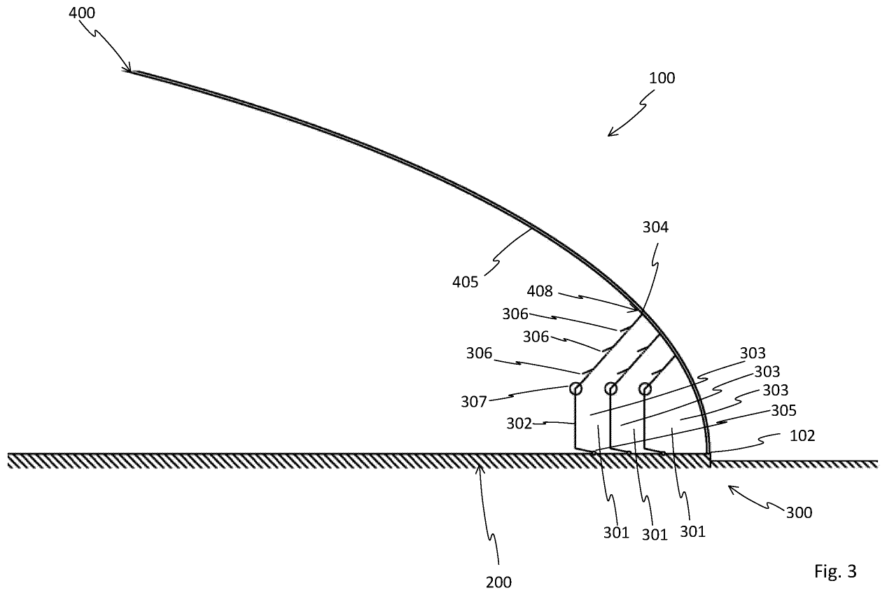

Now turning to FIG. 3. In order to further improve safety in the climate hall 100, one or more fender systems 300 may be arranged along parts of the inner side walls 405 of the climate hall 100. In case the driver should lose control of the vehicle and the vehicle should accidentally run towards the wall of the climate hall 100, the fender system 300 will absorb the kinetic energy from the vehicle upon impact, and slow down the vehicle. In this manner, the risk of damages to the driver, the vehicle and the climate hall 100, may be substantially reduced. The fender system 300 may be integral with the inner side wall portion 408 of the flexible wall arrangement 400. Alternatively, the fender system 300 may be a stand-alone unit. FIG. 3 illustrates an integrated fender system 300 arranged along at least a part of the inner side wall 405 according to an embodiment of the invention.

The fender system 300 may have more than one deformation zone 301 arranged one after the other as seen in a direction from the inside of the climate hall 100 towards the flexible wall arrangement 400. The example shown in FIG. 3 comprises three deformation zones 301.

A deformation zone 301 may be made of a flexible material 302 filled with a filling 303. The filling 303 may be air, soft cushion material, or any other material suitable for dampening the impact by energy absorption, or combinations thereof. It is to be understood that a deformation zone 301 with remained function may be filled with air only. In the event of the deformation zone 301 is filled with air, it is to be understood that the deformation zone 301 may be formed as a sealed, air tight bag.

It is to be understood that in the event two or more deformation zones 301 are arranged one after the other, the deformation zones 301 may have different dampening.

The flexible material 302 may be of the same type as the flexible wall arrangement 400, or it may be a different type of material.

The upper portion 304 of the flexible material 302 may be fastened on the inner side wall portion 408. The flexible material 302 extends downwards to the interior ground surface 200, and the lower portion 305 of the flexible material 302 may be fastened in the interior ground surface 200. It is also to be understood that it may be fastened in the foundation 102 of the climate hall.

In the event the filling 303 is air, the air pressure in the deformation zone(s) 301 of the fender system 300 may be higher than the air pressure of the air in the climate hall 100. This overpressure may be established by a ventilation system (not disclosed) that is separate from the ventilation plant 103 of the climate hall 100. Alternatively, it may be established by the same ventilation plant 103. Due to the higher pressure in the fender system 300, the excess of the flexible material 302 will extend inwards to the center of the climate hall 100, creating soft cushions along the walls.

The fender system 300 may be equipped with one or more air outlet valves 306. In the event that a vehicle collides with the fender system 300 the deformation zone(s) 301 will be compressed by the vehicle, and this causes the air outlet valve(s) to open, and air to be exhausted from the deformation zone(s) 301. This will gradually slow down the vehicle, while minimizing the risk of tearing the flexible material 302.

The deformation zone(s) 301 may also be equipped with weak points 307. The weak points 307 ensure that, should the impact from the vehicle be too powerful such that it risks tearing the material in the flexible wall arrangement 400, the deformation zone(s) 301 will be torn at the weak points 307 before the tension in the material is strong enough to break the inner side wall portion 408 of the climate hall 100. The weak points 307 may be arranged in the interface between the fender system 300 and the inner wall portion 408 of the flexible wall arrangement 400.

It should be noted that even if the vehicle should go through the fender system 300 and hit the flexible wall arrangement 400, the material in the latter will burst. Thus is the risk of personal injuries as well as damages to the vehicle substantially reduced as compared to conventional buildings in steel.

FIG. 4 illustrates a vertical cross-section of the climate hall 100, with a number of features according to different embodiments of the invention.

In the upper part of FIG. 4 it is shown that at least a part of the ceiling portion 401 may be provided with a heating foil 402. In the present embodiment the heating foil 402 is arranged on the inside of the top part of the ceiling portion 401. When required, the heating foil 402 may be used to provide heat to the inside of the ceiling portion 401 which will dissipate also to the outside of the ceiling portion 401, i.e. to the roof 403 of the climate hall 100. When the climate hall 100 is run as a cold climate test hall, and the outdoor climate is also cold, there is a risk of formation of ice or accumulation of snow on the roof 403 of the climate hall 100. Such formation of ice and/or snow masses may affect the construction of the climate hall 100 negatively, and the weight of the masses may cause the roof 403 to collapse. By the use of the heating foil 402, the roof 403 will be heated, despite the cold inner climate, and consequently melt the ice and/or snow on the roof 403, preventing it from accumulating. The melted ice and/or snow may run down along the outer side walls 404 of the climate hall 100 and gather on the exterior ground surface 209 adjacent the outer side walls 404. This embodiment allows the climate inside the climate hall 100 to be set independently of the outdoor climate, without risking the construction of the climate hall 100 to be affected.

When the flexible wall arrangement 400 is a double wall structure, the heating foil 402 described above may be arranged on at least a part of the inner side of the outer wall 404.

In FIG. 4 also an illumination arrangement 500 is illustrated, according to an embodiment of the invention. In the present arrangement one or more light sources 501 are recessed into the interior ground surface 200. The light sources 501 may be, but are not limited to, incandescent lights, fluorescent lights, light emitting diodes (LED), or any other type of light sources. Above the light sources 501, typically at interior ground level, a substantially transparent plate 502 is arranged. By way of example, the transparent plate 502 may be made of glass, Plexiglas, or any other transparent solid material. The light sources 501 in the recess of the present embodiment are directed upwards such that, when the lights are switched on, the light sources 501 shed light on the inside of the inner wall 405 and ceiling portions 401. The inner wall 405 and ceiling portions 401 will act as a diffusor of the light. Preferably the inner wall 405 and ceiling portions 401 have a light, e.g. white, inner surfaces. Hence, the recessed illumination arrangement 500 in combination with the inner wall 405 and ceiling portions 401 may be seen as providing an indirect illumination of the climate hall 100. By this arrangement the risk of light dazzling the driver of the vehicle may be eliminated. Further, there is no need of any pillars supporting floodlight.

One or more of the above mentioned illumination arrangements 500 may be arranged at least along inner side walls 405 of the climate hall 100. However, in other embodiments the illumination arrangement 500 may be arranged also in other parts of the interior ground surface 200 of the climate hall 100. At least in such cases, the transparent plate 502 needs to be able to support the pressure from passing vehicles, e.g. a tire of a passing car, without being damaged.

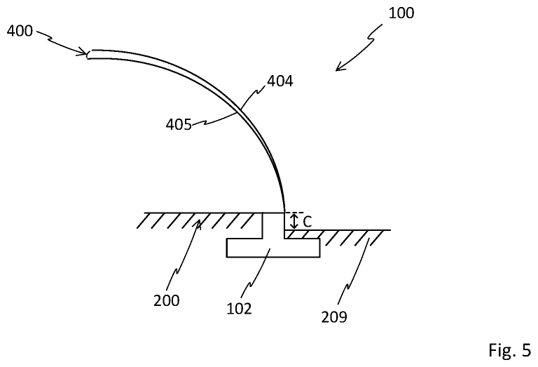

Now turning to FIG. 5. The interior ground surface 200 inside the climate hall 100 may be arranged in level with or above an upper portion of the foundation 102. The illustration in FIG. 5 shows the interior ground surface 200 arranged in level with the upper portion of the foundation 102, according to an embodiment of the invention. Note that the shape of the foundation 102 illustrated in FIG. 5 is just one of many possible shapes suitable for the foundation 102. By this embodiment, the foundation 102 does not constitute an obstacle for a vehicle should the vehicle accidentally travel towards the inner wall 405 of the climate hall 100. The vehicle may thus run through the flexible wall arrangement 400 without the risk of colliding with any solid foundation at high impact. This, in turn, improves safety in the climate hall 100 for the driver as well as the vehicle.

FIG. 5 also illustrates that the exterior ground surface 209 of the climate hall 100, as seen adjacent the foundation 102, is arranged below the upper portion of the foundation 102. Given only as an example, the level difference C between the upper portion of the foundation 102 and the exterior ground surface 209 may be, but is not limited to, between 20 to 30 cm. As mentioned previously in the discussion regarding the heating foil 402 of FIG. 4, in the case of winter climate outside of the climate hall 100, ice and/or snow may gather on the exterior ground surface 209 adjacent the outer wall 404 of the climate hall 100. By the arrangement of the exterior ground surface 209 being lower than the upper portion of the foundation 102, snow clearance by means of a snow plow may be performed along the outer wall 404 of the climate hall 100, without the snow plow coming in contact with outer wall 404 of the flexible wall arrangement 400. In this manner the risk of tearing the flexible wall arrangement 400 by the snow plow is eliminated.

The invention has been described above as a climate hall 100 suitable for testing vehicles configured to be driven on the ground, such as personal cars, motorcycles, buses or trucks. It is to be understood that also other types of vehicles may be tested, such as drones and other future vehicles.

1. A climate hall for vehicle testing, comprising:
a foundation;
a ventilation plant; and
a flexible wall arrangement extending along and sealingly joined to the foundation and wherein the ventilation plant is configured to establish an overpressure inside the flexible wall arrangement, thereby causing the flexible wall arrangement to erect to form a hall having an inner volume which is at least partly defined by inner side wall portions and a ceiling portion formed by said flexible wall arrangement, and wherein the ventilation plant is further configured to establish a controlled climate inside the hall, thereby forming a climate hall; and wherein the climate hall further comprises at least an interior ground surface configured for vehicle testing, wherein the interior ground surface comprises a test arrangement with one or more environmental features from of a group of consisting of asphalt, ice, snow, water, sand, gravel, stone, dirt, a designed friction surface and rail; and
wherein the climate hall further comprises a fender system arranged along at least a part of the inner side wall portions.

2. The climate hall according to claim 1, wherein the fender system comprises at least two deformation zones arranged one after the other as seen in a direction from the inside of the climate hall towards the flexible wall arrangement.

3. The climate hall according to claim 1, wherein the fender system is integral with the inner side wall portion of the flexible wall arrangement, or wherein the fender system is a standalone unit.

4. The climate hall according to claim 1, wherein at least a part of the ceiling portion is provided with a heating foil.

5. The climate hall according to claim 1, wherein the flexible wall arrangement is a double wall structure comprising an inner wall and an outer wall, and wherein at least a part of an inner wall portion of the outer wall is provided with a heating foil.

6. The climate hall according to claim 1, wherein the interior ground surface inside the climate hall is arranged in level with or above an upper portion of the foundation.

7. The climate hall according to claim 1, wherein an exterior ground surface outside of the climate hall, as seen adjacent the foundation, is arranged below the upper portion of the foundation.

8. The climate hall according to claim 1, further comprising an illumination arrangement, wherein the illumination arrangement is recessed into the interior ground surface of the climate hall, at least along inner side walls of the climate hall.

9. The climate hall according to claim 1, wherein the interior ground surface further comprises a vehicle acceleration section having a length of at least 25 meters, and followed by a vehicle test section having a length of at least 150 meters.

10. The climate hall according to claim 1, wherein the interior ground surface further comprises a vehicle acceleration section having a length of at least 75 meters, and followed by a vehicle test section having a length of at least 400 meters.

11. The climate hall according to claim 1, wherein the interior ground surface further comprises a vehicle acceleration section having a length of at least 150 meters, and followed by a vehicle test section having a length of at least 800 meters.
